(19) United States
(12) Patent Application Publication
(10) Pub. No.: US 2008/0011955 A1
(43) Pub. Date: Jan. 17, 2008

(54) Method and Apparatus for Treatment of Signals Obtained from Photomultiplier Tubes

(75) Inventors: Giulio Di Bene, Navacchio (IT); Andrea Cremoncini, Sarzana (IT); Antonio Sani, Torre Del Lago (IT); Daniele Bianchi, Lucca (IT); Marco Lazzarotti, Pisa (IT)

Correspondence Address: DENNISON, SCHULTZ & MACDONALD, 1727 KING STREET, SUITE 105, ALEXANDRIA, VA, 22314, US

(73) Assignee: I.S.E. INGEGNERIA DEI SISTEMI ELETTRONICI S.R.L., Migliarino Pisano (IT)

(21) Appl. No.: 11/577,359

(22) PCT Filed: Oct. 17, 2005
(86) PCT No.: PCT/IB05/03098

§ 371 Date: May 21, 2007

(30) Foreign Application Priority Data
Oct. 18, 2004 (IT) PI2004A000078

(51) Int. Cl. G01T 1/20

(52) U.S. Cl. 250/366

(57) ABSTRACT

An apparatus for treatment of signals obtained from photomultiplier tubes, in particular for carrying out a PET, by at least one couple of scintillators associated to photomultiplier tubes (100, 200). For each head (100) of sensors, a relative phototube (3) generates current pulses that are weighed by two resistive chains (6), each of which generates two output currents, and respectively X′_{A}, X′_{B} for the first chain and Y′_{A}, Y′_{B} for the second chain. The phototube (3) generates also a synchronization signal (S′), or last dynode signal, that serves as signals synchronism indicator for a coincidence comparation with signals coming from the other phototube of a paired head (200). The current pulses are transformed into voltage pulses and processed by correcting circuits (40, 41, 42 and 43), obtaining respective transformed signals XA, XB, and YA, YB, whereas the last dynode signals S′ are amplified at S by a amplifying block (44). The signals reach a board (47) that carries out a sampling of the signals, their conversion into numeric values, a coincidence comparation and transfers them to a PC (49) through an USB interface (48). The software present on the PC (49) computes then the received signals and carries out a reconstruction of the images, which are then final result of the PET. The correcting circuits (40, 41, 42 and 43) of the position signals of the phototube at the same obtain a position signal with a controlled peak value, in order to retrieve the position immediately after the detection of a coincidence, and a quick decay of the signals after the peak value, within a time such that the probability of pile-up between different signals is minimum.

### FIELD OF THE INVENTION

The present invention relates to an apparatus for amplification of position signals obtained from a photomultiplier tube sensitive to position (Position Sensitive Photo Multiplier Tube or PSPMT), also called “phototube”. PSPMTs or phototubes are used for measuring at the same time the presence, the position and the intensity of photon packets, and can be used in different applications. Among them the following applications are well known: in the field of medical physics, the so-called “Gamma Camera” and the apparatus for executing a “PET” (Positron Emission Tomography) and a “SPECT” (Single Photon Emission Tomography). The present invention is of particular interest in some types of apparatus for executing a PET.

### DESCRIPTION OF THE PRIOR ART

Normally, the known apparatus for executing a PET provide a space in which the object or the subject to analyses which often is a human or an animal, are placed. In case of PET on humans its use is frequent for diagnostic purposes, whereas in case of PET on animals, they are normally cavys or rats commonly used in medicine or pharmacology. In both cases, in the body substances are perfused capable of highlighting particular organs or parts by means of transmission of gamma photons, which are received by the sensors of the apparatus that maps their position. In case of PET on humans larger apparatus are used with respect to the case of small animals, needing in the former case a much higher number of sensors.

The sensors consist of an array of scintillators deputed to receive the gamma photons coming from the tested body. The scintillators convert a part of the incident gamma radiations into photons having a wavelength responsive to the material. The photons coming from the scintillators associated to a phototube hit the cathode of the latter from which five signals derive, and precisely:
a “last dynode” signal, necessary for synchronizing the data and for testing the presence of coincidences with other events, whose existence is indication of a β⁺ decay to count.
four position signals X_{A},X_{B},Y_{A},Y_{B}, from whose acquisition and processing various data are obtained, among which the position in a plane X-Y of the point where the gamma photon was revealed by the scintillator. The x,y position of the point, in particular, is measured by means of linear interpolation of the X_{A},X_{B} and Y_{A},Y_{B} by the formula
   x=(X_{A}−X_{B})/(X_{A}+X_{B})
   y=(Y_{A}−Y_{B})/(Y_{A}+Y_{B}).

As well known, in the PET a point of a phototube with x,y coordinates is acquired only if, contemporaneously, a sensor of another phototube has detected another event in a position opposite to the first. This because the transmission of positrons in PET is made through a decay in the x,y point with transmission of two particles having zero momentum, and then moving on a same line in opposite directions.

In SPECT this coincidence is not detected, and the signal of last dynode at exit of the phototube is used for establishing the occurrence of a scintillation.

In figures from 1 to 3 three different known ways are shown for arranging the sensors. The relative phototubes or PSPMT are advantageously not shown, but are fixed to the sensors outside the measurement room, by means of beams of anodes and a signal division electronic board. The three types of PET shown are different from each other, in particular, for the number and the spatial arrangement of the sensors and for the type and the number of phototubes used for generating the signals.

The PET of FIG. 1 or 2 provides respective arrays 1 and 2 of sensors fixed around the space where the body C to analyse moves, which emits gamma photons as indicated by the small radial arrows. In particular, in the PET of FIG. 1 the crystals 1 are arranged ring-like and are connected in a way not shown to photomultiplier tubes normally by means of optical fibres; the ring-like arrangement allows detecting the emissions at 360° without any movement. In the PET of FIG. 2, instead, the crystals 2 are arranged according to several plane arrays arranged as a N sides polygon, as an approximation of the ring-like configuration of FIG. 1. The tubes, in this case, are located directly behind the sensors arrays 2. Even in this case the acquisition is carried out at 360° without movement.

Instead, the PET of FIG. 3 has two opposite arrays of scintillators 100 and 200 (or four scintillators spaced 90°) and caused to step-rotate about the space of analysis. The detection of gamma rays coming from body C is carried out at various angles causing the arrays 100 and 200 to rotate integrally about their central axis a in order to cover the 360°.

As shown in FIG. 4, in sensor 190 the arrays of crystals 4 is plane and directly glued on phototube 5. In particular, the kind of PET of FIG. 3 lets the sensors to be arranged as those indicated in FIG. 4, i.e. to provide arrays of sensors 4 that are small enough in order to need a single photomultiplier tube 5, thus obtaining both a simplification of the electronics and a reduction of the costs.

On the other hand, the arrays of sensors of the types of FIGS. 1 and 2, being larger, require each many phototubes, and in the case of FIG. 1 also have a curved geometry that requires the connection to the phototubes by means of optical fibres, with a more complex structure and higher costs.

However, the PET apparatus presently on the market have in most cases a structure like that of FIGS. 1 and 2. In fact, the structure of FIG. 3 is interesting but still under investigation (see for example R. Pani, A. Soluri, R. Scafe, R. Pellegrini, A. Tati', F. Scopinaro, G. De Vincentis, T. Gigliotti, A. Festinesi, F. Garibaldi, A. Del Guerra, “A compact gamma ray imager for oncology”, Nucl Instr and Methods 2002, A477, 509-513). The adoption of the configuration of FIG. 3, in fact, can have some limits concerning clearness of the PET image when, in the presence of a considerable activity in the point of observation the signals are taken without an appropriate processing.

In fact, the adoption of a single photomultiplier tube for each scintillator, when its surface is larger than a few square cm, increases the amount of events versus time, which it must detect with normal values of activity in the point of observation.

For example, in the presence of an activity of 1 milliCurie (about 37.000.000 events per second), a 25 cm² scintillator located at a distance of 10 cm from the source receives about 730.000 events per second. The events are distributed in a not uniform way versus time, according to a Poisson distribution, and it is therefore highly probable that a single event is processed before that the effects of previous events are ended, giving rise to the so-called “pile-up” phenomenon, i.e. the sum of the amplitude of a pulse and the residue amplitude of previous pulses. The consequence of the pile-up is a displacement of a calculated position of a point from the actual one, which implies a considerable degradation of the readability of an image.

If this fact is taken into account the need is clear of quick processing all the events, or at least most of them, so that it is possible to process correctly events that occur in a rapid succession.

A further need is that the pulses obtained from a phototube should develop in order to reach a maximum value after enough time, to let the circuit of coincidence to accept those pulses: in this way only “good” signals can be detected, i.e. those that are obtained in coincidence between them, thus simplifying remarkably their processing.

The relevance of the pile-up phenomenon is reduced, up to become irrelevant, since the size of the photomultipliers is reduced, increasing their number, but also increasing complexity and costs of all the apparatus. This is the case for example of the structures of FIGS. 1 and 2.

A further drawback is that, in order to provide a position signal at the exit of a phototube, a resistive chain for weighing the pulses is normally used. This resistive chain introduces a parasitic delay that creates a distortion on the position signal.

### SUMMARY OF THE INVENTION

It is therefore a feature of the present invention to provide an apparatus for treatment of signals obtained from photomultiplier tubes, in particular for executing a PET, which has larger photomultipliers with respect to the known apparatus and that at the same time limits the pile-up phenomenon.

It is another feature of the present invention to provide such an apparatus that has an electronics that lets the signals of the phototube to develop in the least time possible and without deteriorating in any way the position signals.

It is a further feature of the present invention to provide such an apparatus that has an electronics capable of eliminating parasitic delays caused by resistive chains for weighing the pulses at exit of the phototube and subsequent distortions on the position signal.

These and other objects are achieved with an apparatus for treatment of signals obtained from photomultiplier tubes or phototubes, each phototube being associated to an array of scintillators deputed to receive gamma photons transmitted by a body being tested; each phototube generating five signals:
a synchronization signal suitable for revealing an occurrence of a scintillation,
four position signals from whose acquisition and processing the position is obtained in a plane of a point where a gamma photon was revealed by said scintillator, said position signals having an origin, a peak value and a decay below a predetermined threshold,
   characterised in that it comprises:
means for setting the peak value of said position signals creating a calculated delay of said peak value with respect to said synchronization signal;
means for accelerating said decay of the position signal downstream of said peak.

Preferably, said means for setting the peak value and said means for accelerating said decay are integrated in a single correcting circuit, said correcting circuit introducing a transfer function suitable for establishing a predetermined number of poles. In particular, said number of poles is comprised between 1 and 10.

Advantageously, said correcting circuit introduces a zero, said zero annulling a pole inserted by a resistive signal division chain.

Preferably, said correcting circuit introduces a transfer function given by the formula:

$$\frac{1 + τ s}{{( 1 + {τ}_{p} s )}^{N}}$$

Advantageously, said correcting circuit is a RC circuit with at least one operational amplifier. In particular, said correcting circuit comprises two operational amplifiers.

In a possible exemplary embodiment, said synchronization signal is suitable for determining a coincidence with another event in order to show an occurrence of a decay, whereby said photomultiplier tube can be used in an apparatus for executing a PET.

### BRIEF DESCRIPTION OF THE DRAWINGS

Further characteristics and the advantages of the apparatus according to the present invention will be made clearer with the following description of an exemplary embodiment thereof, exemplifying but not limitative, with reference to the attached drawings wherein:

FIG. 5 shows a diagrammatical view of a two PET heads like that of FIG. 3, having a processing section according to the invention for processing signals coming from a phototube;

FIG. 6 shows a synchronization signal and a position signal with peak value delayed with respect to the synchronization signal and with accelerated decay after the peak value according to the present invention;

FIG. 7 shows the transfer functions of the phototube, of the resistive divider, and of the analog processing circuit for positioning and for accelerating the decay starting from a actual position signal, showing below the wave forms of the signal present exiting from the respective blocks;

FIG. 8 shows a preferred exemplary embodiment of the processing section of the position signals, with the electric scheme of the whole preamplification unit, which contains the amplifier of the “last dynode” signal and four instances of the correcting circuit of the respective position channels;

FIG. 9 shows a detailed view of the correcting circuit of a single position channel of the position signals of FIG. 8;

FIG. 10 shows a graph for computing the number of poles N of the transfer function introduced by a circuit like that of FIG. 9 responsive to the ratio Tsettling/Tpeak.

### DESCRIPTION OF PREFERRED EXEMPLARY EMBODIMENTS

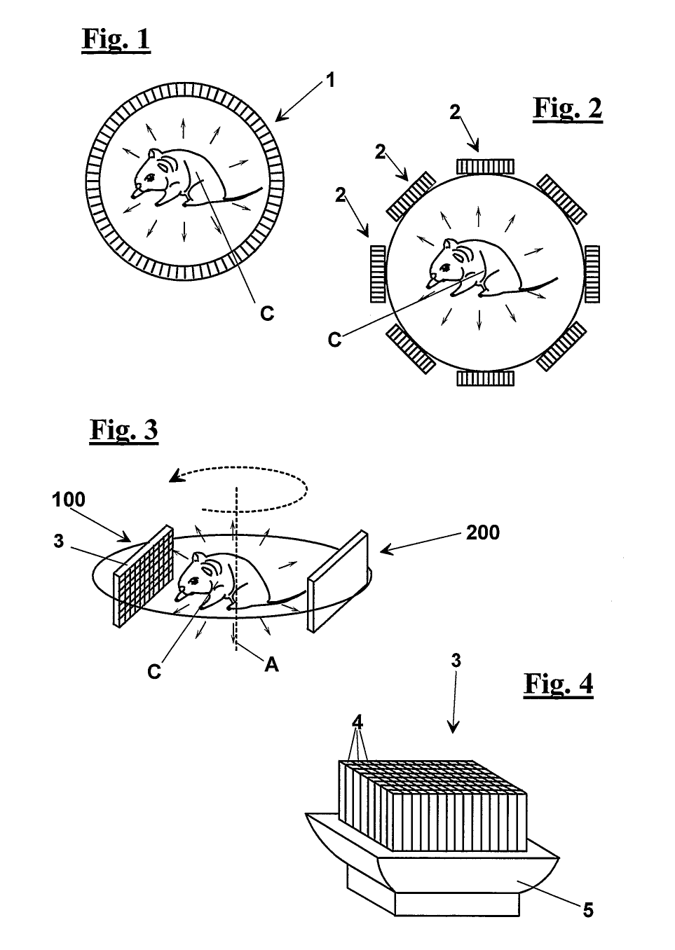

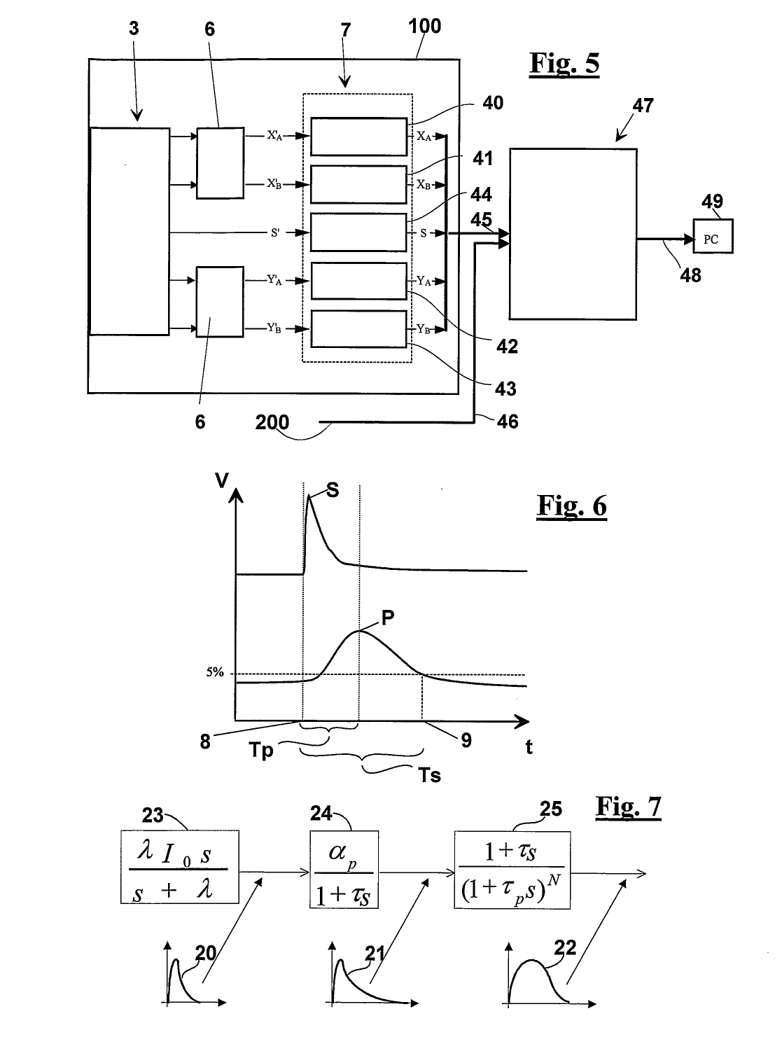

An apparatus for executing a PET according to the architecture of FIG. 3 is shown in FIG. 5. For a sensors head 100 a phototube 3 generates current pulses that are weighed by two resistive chains 6, each of which generates two output currents, and respectively X′_{A}, X′_{B} for the first chain and Y′A, Y′B for the second chain; phototube 3 generates also a synchronization signal S′, or last dynode signal, that synchronizes the signals and checks the coincidence among signals coming from other phototubes of a paired head 200.

The current pulses are transformed into voltage pulses and processed by blocks 40, 41, 42 and 43, obtaining respective transformed signals X_{A}, X_{B}, and Y_{A}, Y_{B}, whereas the last dynode signals S′ are amplified into S by block 44.

From head 100 signals X_{A}, X_{B}, and Y_{A}, Y_{B}, and S, come and then reach, through a bus 45, a processing block 47. By head 200 (not shown) similar signals are treated in the same way and reach block 47 through bus 46.

Block 47 carries out a sampling operation of the signals, their conversion into numeric values, a coincidence comparation thereof and transfers them to PC 49 through an USB interface 48. The software residing in PC 49 computes then the received signals and carries out a reconstruction of the images, which are then the final result of the PET.

With reference to FIG. 6, a position signal, in particular with coordinates X_{A},X_{B},Y_{A},Y_{B}, necessary for determining a point in a plane X-Y where a gamma photon was revealed by the scintillator in the configuration of FIG. 3, has been treated according to the invention for setting its peak value P with respect to a “last dynode” signal or synchronization signal S, which is used, as well known in the art, for checking the presence of coincidences among other events through a detecting circuit of known type, indicated by block 47 of FIG. 5.

In particular, as well known in the art, all the last dynode signals S reach, in turn, a coincidence circuit, included in block 47 of FIG. 5, which selects those that coincide temporally and come from different phototubes, in the present case coming from heads 100 and 200, with a precision of several nanoseconds. The time that the detector of coincidence spends to give the response is several nanoseconds. Therefore, if the starting position signals coming from the scintillation that occurs at instant 8 reach the computer after a delay Tp longer than this time, the computer is capable in real time of treating only position signals having peak value P coming from different phototubes and that correspond to each coincidence between signals S selected by the detector.

Furthermore, according to the invention, the position signal X_{A}, X_{B}, Y_{A}, Y_{B}, not only has a peak value P delayed with respect to the synchronization signal 10, but it has also an accelerated decay immediately after the peak. In this way the risk of “pile-up” is remarkably lower. The time of decay is indicated as Ts, which is the time between the scintillation 8 and the instant 9 where the signal drops under the 5% of the peak value.

To obtain a desired arrangement, in a preferred embodiment of the present invention, with reference to FIG. 7, qualitative wave forms are shown, responsive to the time:
of the actual position signal 20 generated by the phototube at a scintillation occurrence and whose transfer function is shown mathematically by expression 23,
of signal 21 deteriorated by the presence of the resistive partition chain, and whose transfer function, which introduces a pole, is given mathematically by expression 24, and
of signal 22 processed by the correcting circuit according to the invention, and whose transfer function is shown mathematically by the expression 25 to obtain desired results, introducing a suitable “number of poles” N.

This signals filtering technique for a phototube can give at the same time the desired results of:
1. obtaining for position signal a controlled peak value time Tp in order to retrieve the position immediately after the instant of decision of the detector of coincidence;
2. to cause the signals peak value to decay quickly, within a time Ts so that the probability of pile-up between different signals is minimum.

Furthermore, there is the further advantage of eliminating the parasitic delay introduced by the resistive chain 6 for weighing the pulses. In fact, the transfer function 25 introduces also a “zero” that eliminates the pole introduced by the resistive chain 6 and shown by the transfer function 24, eliminating the distortion on the position signal.

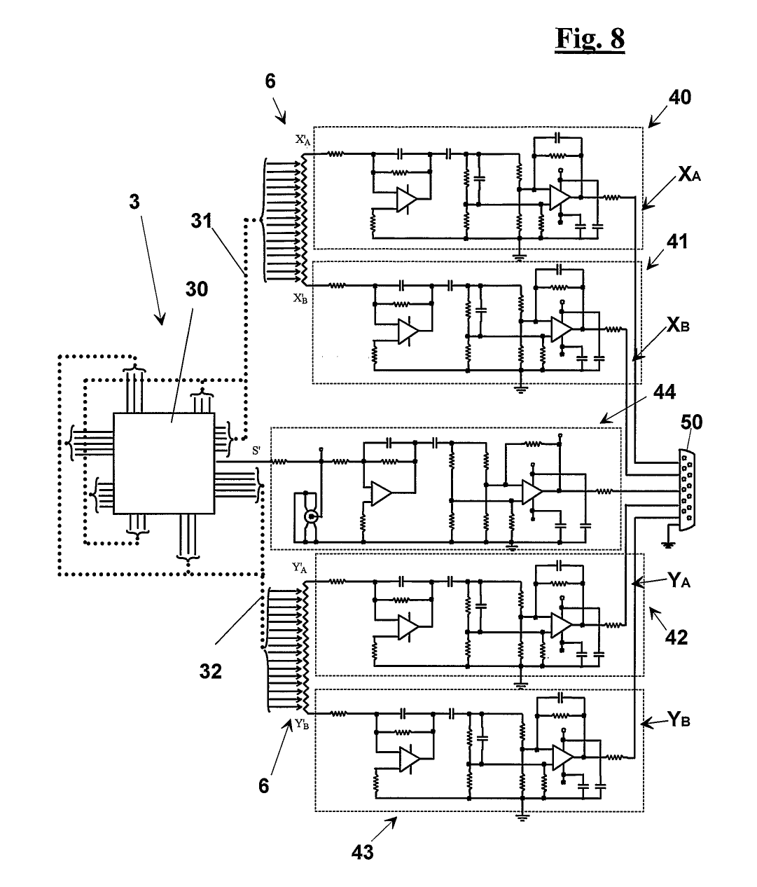

With reference to FIG. 8, the electric scheme of the whole preamplification unit is arranged directly on the base 30 of the phototube 3 and contains the amplifier of the “last dynode” signal S′ and four instances 40-43 of the analog processing circuit of position signals X_{A},X_{B},Y_{A},Y_{B}. The circuits 40-43 are equal (shown enlarged in FIG. 9), one for each four output channels of the phototube. Furthermore, an amplification circuit 44 is provided for last dynode signal S.

From FIG. 8 the detail of the electric processing scheme is shown for one of the output channel of the phototube. In this case, the correcting circuit provides a transfer function that contains a zero and three poles (N=3) and has been made with only two operational amplifiers. In case a higher number of poles is necessary, the circuit of FIG. 9 can be modified without particular efforts by a skilled person. The decision on the necessary number of poles N is possible as described below.

The whole section of FIG. 8 can be made with surface components assembled on a printed circuit that can be adapted dimensionally to a used phototube. An example of a phototube available on the market is produced by the company HAMAMATSU with the model R2486. The printed circuit contains both two resistive partitors 6 (one for X axis and one for Y axis) to obtain the coordinates of the barycentre of a beam that hits both the circuits 40-43, and a circuit 44 for amplification of the synchronization signal.

It is possible to design the correcting circuit responsive to the ratio between peak value time Tp, i.e. the delay of the peak value of the signal with respect to the scintillation occurrence, and a “settling” time Ts, i.e. the time for a transient of decay of the signal up to 5% of the amplitude of the peak value (see FIG. 6).

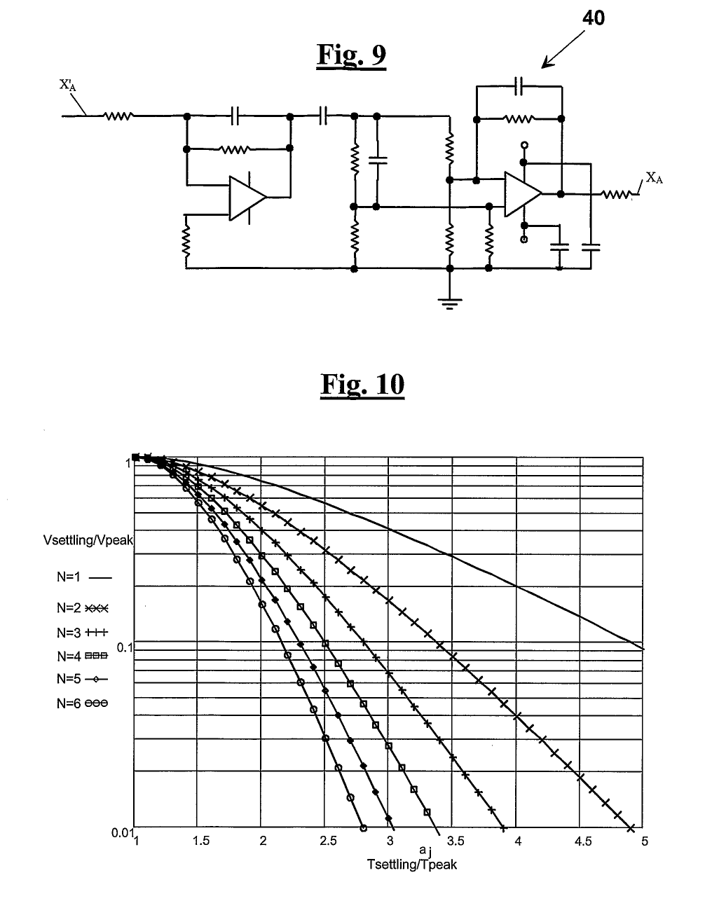

The link between Tp and Ts is shown in FIG. 10 responsive to the number of poles introduced by the transfer function of the correcting circuit. The graph of FIG. 10 can be used as abacus, and is generated as a function of the algorithm of the processing circuit:once fixed (axis Y) the ratio of the signal at which the transient of the signal same has ended, it is possible to determine the value N (number of poles) that satisfies a desired Tp/Ts ratio. Obviously this depends on the number of signals that reach statistically each single crystal versus time.

From FIG. 10 it can be seen that, once chosen the tolerance, expressed as percentage of the peak value, in which the transient is considered ended, it is possible to determine the necessary number of poles versus the maximum desired Tp and Ts times.

The peak time, in turn, is function of the position of the poles according to the expression Tp=(N−1)τₚ, where 1/τₚ is the real value of the poles of correcting function 25 of FIG. 7.

To sum up, according to the present invention, it is possible:
to eliminate the pole inserted by the resistive chain 6 replaced by a corresponding zero in transfer function 25,
to arrange the circuit in such a way that the peak value time Tp has a desired value,
to determine the number N of real coincident poles of the correcting circuit in order to obtain a desired value of the ratio Ts/Tp, fixing in particular the decrease of the duration of the transient caused by the increase of N.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. An apparatus for treatment of signals obtained from photomultiplier tubes, each tube being associated to an array of scintillators deputed to receive gamma photons transmitted by a body being tested; each photomultiplier tube generating five signals:
a synchronization signal suitable for revealing an occurrence of a scintillation,
four position signals from whose acquisition and processing the position is obtained in a plane of a point where a gamma photon was revealed by said scintillator, said position signals having an origin, a peak value and a decay below a predetermined threshold,
characterised in that it comprises:
means for setting the peak value of said position signals creating a calculated delay of said peak value with respect to said synchronization signal;
means for accelerating said decay of the position signal downstream of said peak.

2. Apparatus according to claim 1, wherein said means for setting the peak value and said means for accelerating said decay are integrated in a single correcting circuit, said correcting circuit introducing a transfer function suitable for establishing a predetermined number of poles.

3. Apparatus, according to claim 2, wherein said number of poles is comprised between 1 and 10.

4. Apparatus, according to claim 2, wherein said correcting circuit introduces a zero, said zero annulling a pole inserted by a resistive signal division chain.

5. Apparatus, according to claim 2, wherein said correcting circuit introduces a transfer function given by the formula:
$$\frac{1 + τ s}{{( 1 + {τ}_{p} s )}^{N}}$$

6. Apparatus, according to claim 2, wherein said correcting circuit is a RC circuit with at least one operational amplifier.

7. Apparatus, according to claim 5, wherein said correcting circuit comprises two operational amplifiers.

8. Apparatus, according to claim 1, wherein said synchronization signal is suitable for determining a coincidence with another event in order to show an occurrence of a decay, whereby said photomultiplier tube can be used in an PET apparatus.
